(19) United States
(12) Patent Application Publication
(10) Pub. No.: US 2021/0365411 A1
(43) Pub. Date: Nov. 25, 2021

(54) ASYNCHRONOUS HOST FILE SYSTEM BASED DATA REPLICATION

(71) Applicant: International Business Machines Corporation, Armonk, NY (US)

(72) Inventors: Ninad S. Palsule, Austin, TX (US); Ravi A. Shankar, Austin, TX (US); James A. Pafumi, Leander, TX (US); PERINKULAM I. GANESH, Round Rock, TX (US); Frank Law Nichols, III, Georgetown, TX (US); JES KIRAN CHITTIGALA, Kukatpally (IN); Lakshmi Yadlapati, Austin, TX (US); Rui Yang, Austin, TX (US); Robert Kenneth Gjertsen, JR., Austin, TX (US); Corradino D. Jones, Austin, TX (US); Denise Marie Genty, Austin, TX (US); Janet Adkins, Austin, TX (US)

(73) Assignee: International Business Machines Corporation, Armonk, NY (US)

(21) Appl. No.: 16/880,298

(22) Filed: May 21, 2020

(51) Int. Cl. G06F 16/178

(52) U.S. Cl. CPC G06F 16/178

(57) ABSTRACT

A write operation storing data in a first storage device is duplicated to a first replication file. A set of differences between a first version of the first replication file determined at a first time and a second version of the first replication file determined at a second time is determined, the set of differences comprising a set of results of duplicated write operations occurring between the first time and the second time. At a second file system, storage of the set of differences in a second storage device is caused, creating a duplicate in the second storage device of the data stored in the first storage device.

### BACKGROUND

The present invention relates generally to a method, system, and computer program product for data replication. More particularly, the present invention relates to a method, system, and computer program product for asynchronous host file system based data replication.

Data replication, in which the same data is stored in multiple storage devices, is important for recovery if one of the storage devices fails. In addition, to provide redundancy if a datacenter becomes unavailable (e.g. due to a power failure or natural disaster), duplicate data is often stored in multiple storage devices at multiple sites connected by a network.

Data replication solutions have been implemented in various components between a software application and a physical storage device. Data can be replicated at the application level, the client virtual machine level, or within a storage subsystem.

A virtual machine, or logical partition, is software that emulates physical computing devices such as a processor, memory, and storage device. A hypervisor is computer software that creates and manages virtual machines. In some hypervisor-based environments, each virtual machine virtualizes its own physical input/output (I/O) resources, such as storage and network devices. In other environments, each virtual machine does not virtualize its own I/O resources. Instead, software (e.g., Virtual I/O Server (VIOS)) located in one virtual machine or logical partition virtualizes physical I/O resources for other, client, logical partitions. Because all I/O from client virtual machines travels through a VIOS, data replication can be implemented in a VIOS as well.

Asynchronous data replication is a method of data backup in which the data is stored in a primary storage device first and then accumulated in a separate location, such as memory or a disk-based journal, before storing the accumulated data in another device. Replicating data asynchronously eliminates I/O delays, since an application storing data does not have to wait for the data to be stored in more than one location, especially if the backup device is located elsewhere on a network from the primary device.

### SUMMARY

The illustrative embodiments provide a method, system, and computer program product. An embodiment includes a method that duplicates, to a first replication file, a write operation storing data in a first storage device. An embodiment determines a set of differences between a first version of the first replication file determined at a first time and a second version of the first replication file determined at a second time, the set of differences comprising a set of results of duplicated write operations occurring between the first time and the second time. An embodiment causes, at a second file system, storage of the set of differences in a second storage device, creating a duplicate in the second storage device of the data stored in the first storage device.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for asynchronous host file system based data replication in accordance with an illustrative embodiment;

FIG. 4 depicts a block diagram of an example configuration for asynchronous host file system based data replication in accordance with an illustrative embodiment;

FIG. 5 depicts an example configuration for asynchronous host file system based data replication in accordance with an illustrative embodiment;

FIG. 6 depicts an example configuration for asynchronous host file system based data replication in accordance with an illustrative embodiment;

FIG. 7 depicts a flowchart of an example process for asynchronous host file system based data replication in accordance with an illustrative embodiment;

FIG. 8 depicts a cloud computing environment according to an embodiment of the present invention; and

FIG. 9 depicts abstraction model layers according to an embodiment of the present invention.

### DETAILED DESCRIPTION

The illustrative embodiments recognize that implementing data replication at the application level requires that each application be responsible for its own replication. However, to preserve the order that writes are performed in and eliminate potential data corruption, replication at the application level must be done in a serial manner. Serial replication cannot take advantage of the performance improvements that can be gained from performing multiple writes in parallel, and is thus a slower than desired process.

The illustrative embodiments recognize that data replication can be implemented at the client virtual machine level, by locally caching data being replicated, and committing and sending a group of writes to a remote site periodically (e.g. every five milliseconds). However, each time an application writes to the same storage location within the waiting window, multiple copies of the data are created. Thus more data than necessary must be cached and sent. The problem is compounded when the network connection between local and remote sites is slow in comparison to the rate at which new data is written, because the slower network speed must be accommodated with additional cache capacity. In addition, if an application waits until an entire group of data is committed, this can cause execution delay in the application. As well, if I/O to one local storage device is replicated and cached separately from I/O to another local storage device, consistency across corresponding remote replications cannot be guaranteed. However, if a single cache is used to track all I/Os across all devices, if the cache fills due to a slower-than-required network connection, the speed benefits of asynchronous replication are lost. Clients also typically restrict access to the needed virtual machines for security reasons.

The illustrative embodiments recognize that data replication can be implemented within a storage subsystem as well, but such a solution is specific to a type of storage subsystem implementation and application program interface, and is also not suited for implementation in a multisite environment in which the sites are connected in a cloud configuration. Consequently, the illustrative embodiments recognize that there is a need to implement data replication in a manner that efficiently preserves data consistency across all of a client virtual machine's storage devices and provides a method of changing the commitment interval based on network speed and other parameters.

The illustrative embodiments recognize that the presently available tools or solutions do not address these needs or provide adequate solutions for these needs. The illustrative embodiments used to describe the invention generally address and solve the above-described problems and other problems related to asynchronous host file system based data replication.

An embodiment can be implemented as a software application. The application implementing an embodiment can be configured as a modification of an existing VIOS or other hypervisor-based system, as a separate application that operates in conjunction with an existing VIOS or other hypervisor-based system, a standalone application, or some combination thereof.

Particularly, some illustrative embodiments provide a method that duplicates, to a replication file, a write operation storing data in a storage device. The method determines a set of differences between first and second versions of the replication file determined at different times and causes storage of the set of differences in a second storage device at a second file system. As a result, the method creates a duplicate in the second storage device of the data stored in the first storage device.

An embodiment is a component of an application that virtualizes one or more storage devices, including for a client virtual machine or logical partition. One embodiment is implemented within one or more VIOSes or virtual machines. Another embodiment is implemented partially within a VIOS or virtual machine and partially within a logical partition that uses the VIOS.

An embodiment receives one or more write operations from a client. The write operations are intended to be stored in a physical storage device the embodiment virtualizes for the client and is replicating. The physical storage device can be a single storage device, part of a Storage Area Network (SAN) configuration, (a SAN is a network of storage devices that can be accessed by multiple computers), or part of another presently-known storage device configuration.

An embodiment implemented within a VIOS or virtual machine duplicates the one or more write operations to a replication file. Because writes to the replication file happen substantially contemporaneously with writes to the physical storage device, the application that is the source of the writes is not subject to commitment delays, improve application execution speed. In one embodiment, the replication file is maintained at the block level, so that for each block changed by a write operation to the physical device, the block's number and changed contents are stored within the replication file. In other embodiments, the replication file is maintained at a different organization level of the physical device. The replication file is stored in a file system usable by the embodiment's VIOS. In one embodiment, the replication file is a thin file, a file for which blocks are not allocated until they are needed to store data. In another embodiment, the replication file is a thick file, a file for which blocks are allocated when the file is created. However, using a thick file requires more space within the file system than using a thin file. If the embodiment's VIOS is virtualizing more than one physical storage device, an embodiment maintains a replication file for each physical storage device. In addition, if two or more VIOSes are virtualizing a single physical storage device in a parallel configuration, a common replication file is maintained for the virtualized physical storage device and each embodiment in a VIOS duplicates the write operations it receives into the common replication file.

An embodiment periodically takes a snapshot of the replication file, preserving a state of the replication file at one or more particular times. An embodiment determines a set of differences between two snapshots, using any presently-available file comparison technique. Thus, the set of differences includes the results of a set of write operations occurring between snapshots of the replication file. In an embodiment in which the replication file is maintained at the block level, the set of differences includes a label for each changed block and the final value of the block. By determining differences between two periodic snapshots, an embodiment ensures that the set of differences includes only the final value of a block or other location, even if the block was written multiple times between the snapshots. In one embodiment, the snapshot functionality is implemented in a VIOS. In another embodiment, the snapshot functionality is implemented in a logical partition rather than the VIOS virtualizing the storage device. Implementing the snapshot functionality in a logical partition when the file system used to store the replication file is a clustered file system allows the snapshot functionality to remain unaffected if the VIOS or virtual machine virtualizing the storage device fails.

An embodiment transmits the set of differences to another site over a network. Including only the final value of a block or other location in the set of differences minimizes the amount of data that is transmitted. In one embodiment, the source and destination sites are collocated. In another embodiment, the source and destination sites are not collocated. Instead, the source site is considered a local site and the destination site is considered a remote site. Separating the two sites is helpful in disaster recovery, because if the local site becomes unavailable for use (e.g. due to a power failure, earthquake, or weather event), the remote site is unlikely to be affected by the same event and remains usable. An embodiment transmits the set of differences in any suitable form. One embodiment transmits the set of differences and a checksum of the data in one package.

At the destination site, another embodiment (receiving embodiment) receives the set of differences, and stores them in a second replication file. The receiving embodiment then performs a set of write operations to store the set of differences in a physical storage device. Thus the embodiment creates a duplicate, in the new storage device, of the data stored in the original storage device. By waiting until the complete set of differences is received before applying them to a storage device, an embodiment prevents failures due to partial replication, for example if only part of the set of differences is received. One receiving embodiment is implemented within a VIOS. Another receiving embodiment is implemented within a virtual machine that virtualizes its own physical devices without using a VIOS.

Because the embodiment creates a duplicate, in the new storage device, of the data stored in the original storage device, if the original storage device fails the client virtual machine or logical partition that was using that storage device can be moved to the destination site and use the replicated storage device there. Using the replicated storage device instead of the original also facilities reconfiguration of a data center when necessary, for example if the original storage device is to be reconfigured or repurposed.

The manner of asynchronous host file system based data replication described herein is unavailable in the presently available methods in the technological field of endeavor pertaining to data replication. A method of an embodiment described herein, when implemented to execute on a device or data processing system, comprises substantial advancement of the functionality of that device or data processing system in duplicating, to a replication file, a write operation storing data in a storage device. The method determines a set of differences between first and second versions of the replication file determined at different times and causes storage of the set of differences in a second storage device at a second file system, thus creating a duplicate in the second storage device of the data stored in the first storage device.

The illustrative embodiments are described with respect to certain types of storage devices, file systems, replication files, logical partitions, virtual machines, VIOSes, transmissions, delays, periods, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

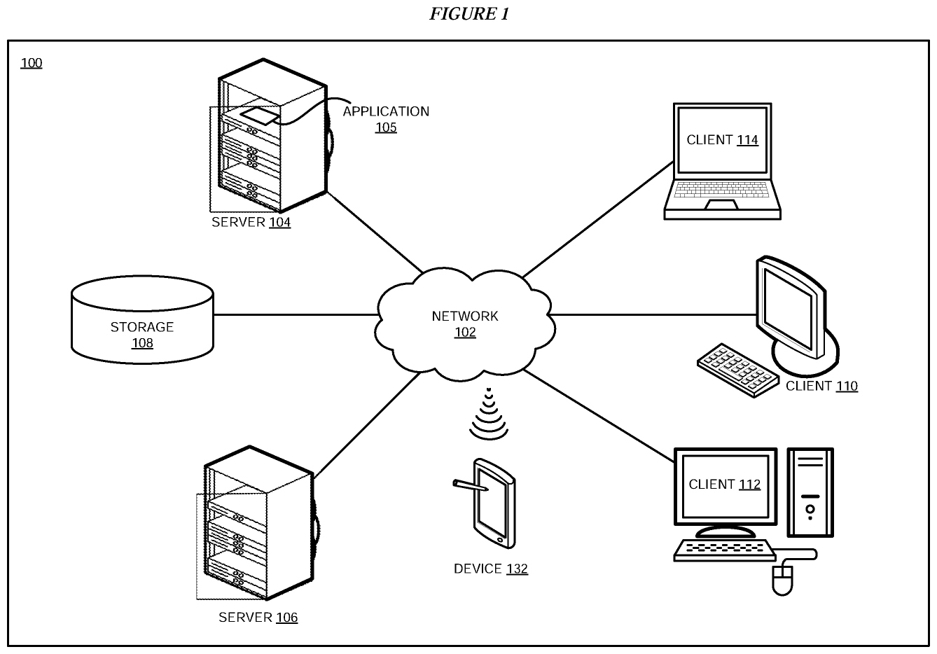

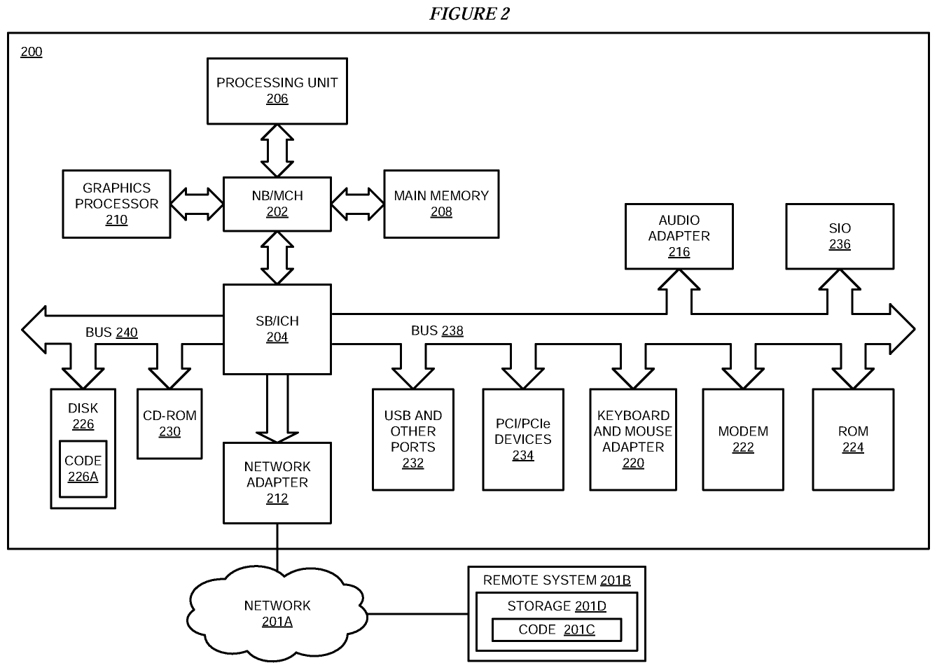

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 implements an embodiment described herein. Application 105 executes in any of servers 104 and 106, clients 110, 112, and 114, and device 132. For example, if servers 104 and 106 each include a physical storage device, application 105 executing in server 104 replicates server 104's physical storage device in server 106.

Servers 104 and 106, storage unit 108, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

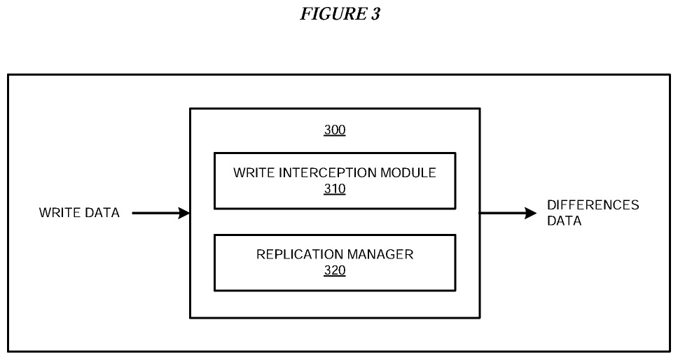

With reference to FIG. 3, this figure depicts a block diagram of an example configuration for asynchronous host file system based data replication in accordance with an illustrative embodiment. Application 300 is an example of application 105 in FIG. 1 and executes in any of servers 104 and 106, clients 110, 112, and 114, and device 132 in FIG. 1.

Write interception module 310 receives one or more write operations from a client. The write operations are intended to be stored in a physical storage device the embodiment virtualizes for the client and is replicating. Module 310 duplicates the one or more write operations to a replication file. In one implementation of module 310, the replication file is maintained at the block level, so that for each block changed by a write operation to the physical device, the block's number and changed contents are stored within the replication file. In other implementations of module 310, the replication file is maintained at a different organization level of the physical device. The replication file is stored in a file system usable by module 310's VIOS. In one implementations of module 310, the replication file is a thin file. In another implementations of module 310, the replication file is a thick file. If module 310's VIOS is virtualizing more than one physical storage device, module 310 maintains a replication file for each physical storage device. In addition, if two or more VIOSes are virtualizing a single physical storage device in a parallel configuration, a common replication file is maintained for the virtualized physical storage device and each instance of module 310 in a VIOS duplicates the write operations it receives into the common replication file.

Replication manager 320 periodically takes a snapshot of the replication file, preserving a state of the replication file at one or more particular times. Module 320 determines a set of differences between two snapshots, using any presently-available file comparison technique. Thus, the set of differences includes the results of a set of write operations occurring between snapshots of the replication file. If the replication file is maintained at the block level, the set of differences includes a label for each changed block and the final value of the block. By determining differences between two periodic snapshots, an embodiment ensures that the set of differences includes only the final value of a block or other location, even if the block was written multiple times between the snapshots. One implementation of module 320 is implemented in a VIOS. Another implementation of module 320 is implemented in a logical partition rather than the VIOS virtualizing the storage device.

Replication manager 320 transmits the set of differences to another site over a network in any suitable form. One implementation of module 320 transmits the set of differences and a checksum of the data in one package.

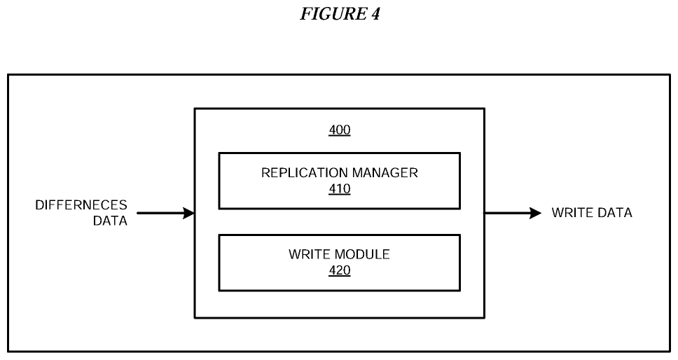

With reference to FIG. 4, this figure depicts a block diagram of an example configuration for asynchronous host file system based data replication in accordance with an illustrative embodiment. Application 400 is an example of application 105 in FIG. 1 and executes in any of servers 104 and 106, clients 110, 112, and 114, and device 132 in FIG. 1.

Replication manager 410 receives the set of differences, and stores them in a second replication file. Write module 420 then performs a set of write operations to store the set of differences in a physical storage device. Thus application 400 creates a duplicate, in the new storage device, of the data stored in the original storage device and sent by application 300.

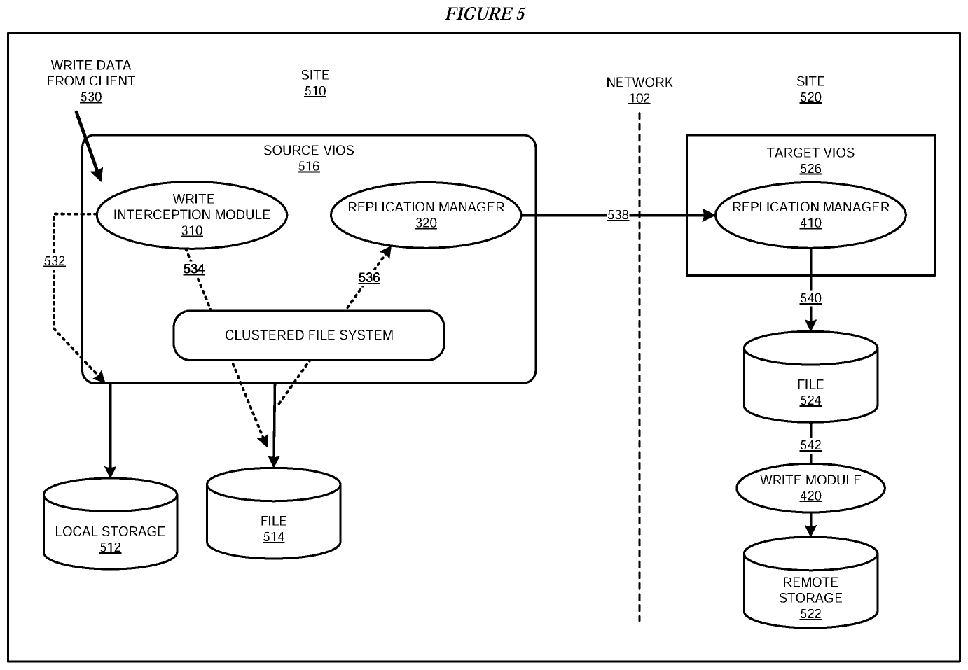

With reference to FIG. 5, this figure depicts an example configuration for asynchronous host file system based data replication in accordance with an illustrative embodiment. The example can be executed using application 300 in FIG. 3 and application 400 in FIG. 4. Network 102 is the same as network 102 in FIG. 1. Write interception module 310 and replication manager 320 are the same as write interception module 310 and replication manager 320 in FIG. 3. Replication manager 410 and write interception module 420 are the same as replication manager 410 and write interception module 420 in FIG. 4.

At site 510, source VIOS 516 receives write data 530, intended for local storage 512, from a client. As depicted, write interception module 310 and replication manager 320 are implemented within source VIOS 516. However, replication manager 320 could also be implemented within a separate logical partition that uses source VIOS 516. At 532, module 310 stores data 530 in local storage 512. Module 310 duplicates write data 530 and, at 534, stores the data in replication file 514. If the replication file is maintained at the block level, for each block changed by a write operation to local storage 512, the block's number and changed contents are stored within replication file 514.

At 536, replication manager 320 periodically takes a snapshot of replication file 514, preserving a state of file 514 at one or more particular times. Module 320 determines a set of differences between two snapshots, using any presently-available file comparison technique. Thus, the set of differences includes the results of a set of write operations occurring between snapshots of the replication file. If file 514 is maintained at the block level, the set of differences includes a label for each changed block and the final value of the block.

At 538, module 320 transmits the set of differences to site 520 over network 102. Including only the final value of a block or other location in the set of differences minimizes the amount of data that is transmitted. At site 520, replication manager 410 implemented in target VIOS 526 receives the set of differences, and at 540 stores them in replication file 524. At 542 write module 420 performs a set of write operations to store the set of differences in remote storage device 522, thus duplicating, in storage 522, the data stored in local storage 512.

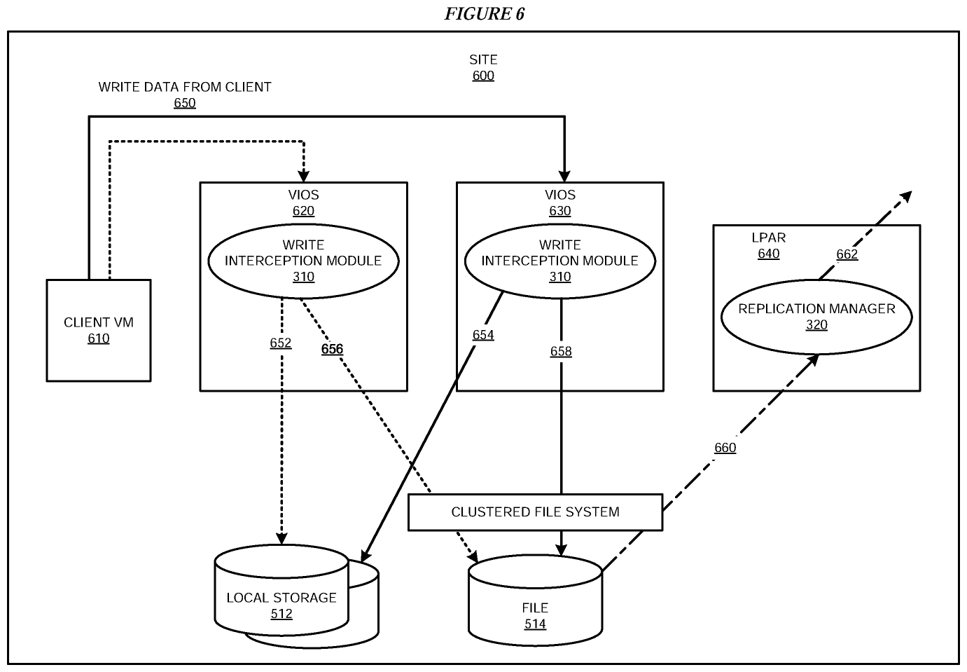

With reference to FIG. 6, this figure depicts an example configuration for asynchronous host file system based data replication in accordance with an illustrative embodiment. The example can be executed using application 300 in FIG. 3 and application 400 in FIG. 4. Network 102 is the same as network 102 in FIG. 1. Write interception module 310 and replication manager 320 are the same as write interception module 310 and replication manager 320 in FIG. 3. Replication manager 410 and write interception module 420 are the same as replication manager 410 and write interception module 420 in FIG. 4. Local storage 512 and replication file 514 are the same as local storage 512 and replication file 514 in FIG. 5.

At site 600, VIOSes 620 and 630 receive write data 650, intended for local storage 512, from client 610. As depicted, VIOSes 620 and 630 are implemented in a parallel configuration, both virtualizing storage 512 for client 610. One instance of write interception module 310 is implemented within VIOS 620, and another instance of write interception module 310 is implemented within VIOS 630. Replication manager 320 is depicted as implemented in logical partition 640. However, replication manager 320 could also be implemented within either of VIOSes 620 and 630. At 652, module 310 in VIOS 620 stores data 650 in local storage 512, duplicates write data 650 and, at 656, stores the data in replication file 514. Alternatively, at 654, module 310 in VIOS 630 stores data 650 in local storage 512 and, at 658, stores the data in replication file 514. If the replication file is maintained at the block level, for each block changed by a write operation to local storage 512 by either VIOS, the block's number and changed contents are stored within replication file 514.

At 660, replication manager 320 periodically takes a snapshot of replication file 514, preserving a state of file 514 at one or more particular times. Module 320 determines a set of differences between two snapshots, using any presently-available file comparison technique. Thus, the set of differences includes the results of a set of write operations occurring between snapshots of the replication file. If file 514 is maintained at the block level, the set of differences includes a label for each changed block and the final value of the block.

At 662, module 320 transmits the set of differences to another site, for example site 520 in FIG. 5, for remote storage.

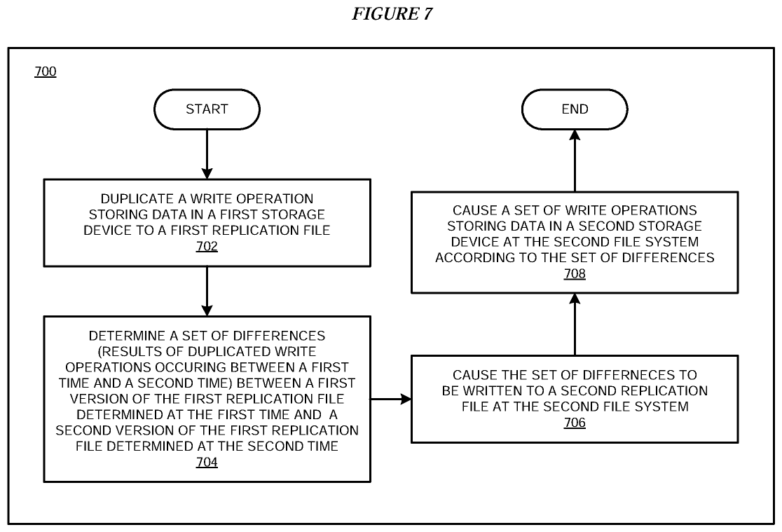

With reference to FIG. 7, this figure depicts a flowchart of an example process for asynchronous host file system based data replication in accordance with an illustrative embodiment. Process 700 can be implemented in application 300 in FIG. 3.

In block 702, the application duplicates a write operation storing data in a first storage device to a first replication file. In block 704, the application determines a set of differences (results of duplicated write operations occurring between a first time and a second time) between a first version of the first replication file determined at the first time and a second version of the first replication file determined at the second time. In block 706, the application causes the set of differences to be written to a second replication file at the second file system. In block 708, the application causes a set of write operations storing data in a second storage device at the second file system according to the set of differences. Then the application ends.

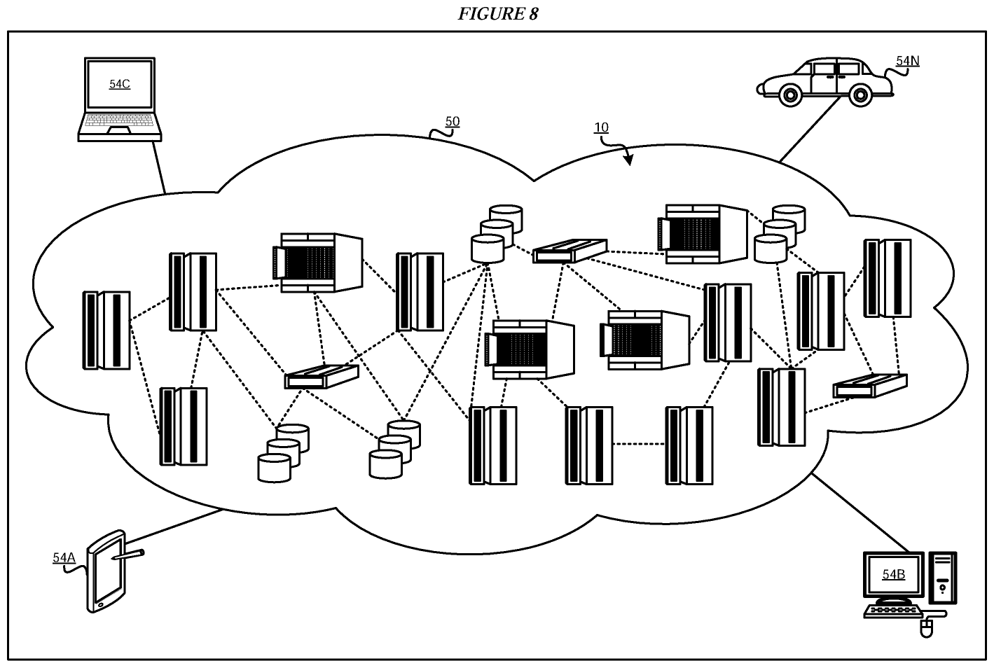

Referring now to FIG. 8, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N depicted are intended to be illustrative only and that computing nodes 10 and cloud computing environment 50 can communicate with any type of computerized device over any type of network and/or network addressable connection (e.g., using a web browser).

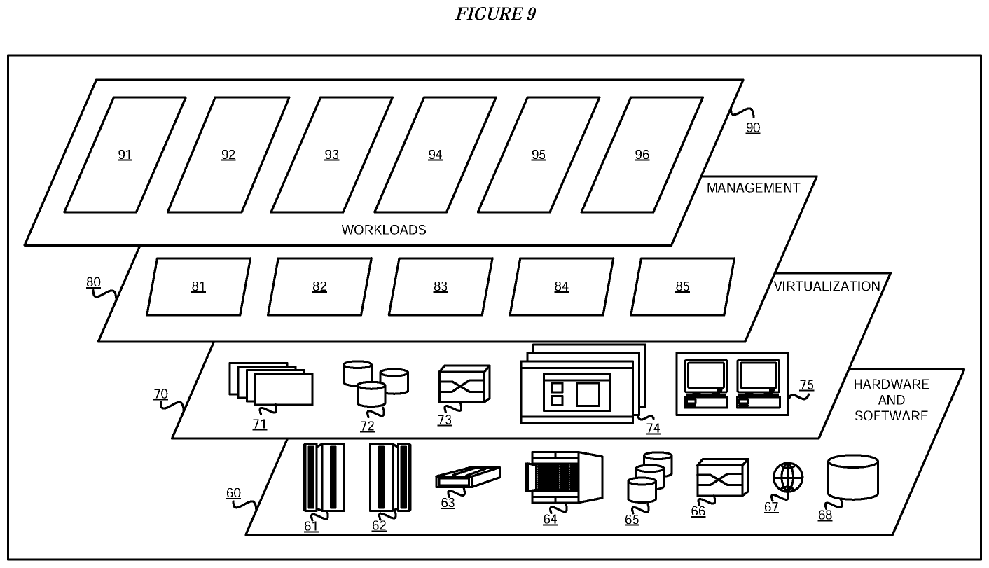

Referring now to FIG. 9, a set of functional abstraction layers provided by cloud computing environment 50 (FIG. 8) is shown. It should be understood in advance that the components, layers, and functions depicted are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and application selection based on cumulative vulnerability risk assessment 96.

Thus, a computer implemented method, system or apparatus, and computer program product are provided in the illustrative embodiments for asynchronous host file system based data replication and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
duplicating, to a first replication file, a write operation storing data in a first storage device;
determining a set of differences between a first version of the first replication file determined at a first time and a second version of the first replication file determined at a second time, the set of differences comprising a set of results of duplicated write operations occurring between the first time and the second time; and
causing, at a second file system, storage of the set of differences in a second storage device, creating a duplicate in the second storage device of the data stored in the first storage device.

2. The computer-implemented method of claim 1, wherein the first replication file is maintained by a clustered file system.

3. The computer-implemented method of claim 1, wherein the first replication file comprises a thin file.

4. The computer-implemented method of claim 1, further comprising:
transmitting, from the first file system to the second file system, the set of differences.

5. The computer-implemented method of claim 1, wherein causing, at a second file system, storage of the set of differences in a second storage device further comprises:
causing, at the second file system, the set of differences to be written to a second replication file; and
causing, at the second file system, a set of write operations to the second storage device, the set of write operations storing data in a second storage device according to the set of differences.

6. The computer-implemented method of claim 1, wherein the first storage device comprises a local storage device, and wherein the second storage device comprises a remote storage device.

7. A computer program product for asynchronous host file system based data replication, the computer program product comprising:
one or more computer readable storage media, and program instructions collectively stored on the one or more computer readable storage media, the program instructions comprising:
program instructions to duplicate, to a first replication file, a write operation storing data in a first storage device;
program instructions to determine a set of differences between a first version of the first replication file determined at a first time and a second version of the first replication file determined at a second time, the set of differences comprising a set of results of duplicated write operations occurring between the first time and the second time; and
program instructions to cause, at a second file system, storage of the set of differences in a second storage device, creating a duplicate in the second storage device of the data stored in the first storage device.

8. The computer program product of claim 7, wherein the first replication file is maintained by a clustered file system.

9. The computer program product of claim 7, wherein the first replication file comprises a thin file.

10. The computer program product of claim 7, further comprising:
program instructions to transmit, from the first file system to the second file system, the set of differences.

11. The computer program product of claim 7, wherein program instructions to cause, at a second file system, storage of the set of differences in a second storage device further comprises:
program instructions to cause, at the second file system, the set of differences to be written to a second replication file; and
program instructions to cause, at the second file system, a set of write operations to the second storage device, the set of write operations storing data in a second storage device according to the set of differences.

12. The computer program product of claim 7, wherein the first storage device comprises a local storage device, and wherein the second storage device comprises a remote storage device.

13. The computer program product of claim 7, wherein the stored program instructions are stored in the at least one of the one or more storage media of a local data processing system, and wherein the stored program instructions are transferred over a network from a remote data processing system.

14. The computer program product of claim 7, wherein the stored program instructions are stored in the at least one of the one or more storage media of a server data processing system, and wherein the stored program instructions are downloaded over a network to a remote data processing system for use in a computer readable storage device associated with the remote data processing system.

15. The computer program product of claim 7, wherein the computer program product is provided as a service in a cloud environment.

16. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to duplicate, to a first replication file, a write operation storing data in a first storage device;
program instructions to determine a set of differences between a first version of the first replication file determined at a first time and a second version of the first replication file determined at a second time, the set of differences comprising a set of results of duplicated write operations occurring between the first time and the second time; and
program instructions to cause, at a second file system, storage of the set of differences in a second storage device, creating a duplicate in the second storage device of the data stored in the first storage device.

17. The computer system of claim 16, wherein the first replication file is maintained by a clustered file system.

18. The computer system of claim 16, wherein the first replication file comprises a thin file.

19. The computer system of claim 16, further comprising:
program instructions to transmit, from the first file system to the second file system, the set of differences.

20. The computer system of claim 16, wherein program instructions to cause, at a second file system, storage of the set of differences in a second storage device further comprises:
program instructions to cause, at the second file system, the set of differences to be written to a second replication file; and
program instructions to cause, at the second file system, a set of write operations to the second storage device, the set of write operations storing data in a second storage device according to the set of differences.
